(19) United States
(12) Patent Application Publication
(10) Pub. No.: US 2025/0250956 A1
(43) Pub. Date: Aug. 7, 2025

(54) FUEL INJECTOR AND VALVE ASSEMBLY FOR PROVIDING FUEL TO A PRIME MOVER

(71) Applicant: Cumming Inc., Columbus, IN (US)

(72) Inventors: Sandip V. Patil, Pune (IN); Samruddhi Palve, Nashik (IN); Hiren Mansukhlal Gardhariya, Pune (IN); Amol Jagannath Bobade, Pune (IN)

(21) Appl. No.: 19/020,217

(22) Filed: Jan. 14, 2025

(30) Foreign Application Priority Data
Feb. 1, 2024 (IN) 202441006691

(51) Int. Cl. F02M 63/00; F02M 61/08

(52) U.S. Cl. CPC F02M 63/0035; F02M 61/08; F02M 63/0078

(57) ABSTRACT

A fuel injector for is provided that includes a valve assembly in a passage of an injector body. The valve assembly includes a plunger and a valve seat that is sealingly engageable by the plunger. The plunger is longitudinally positioned in the injector body so that an inlet into the injector body upstream of the valve seat is partially open while the plunger is sealingly engaged to the valve seat. The plunger is longitudinally displaced in the passage to open a flow path through the valve seat while progressively increasing the opening size of the flow path and the inlet.

### CROSS-REFERENCE TO RELATED APPLICATION

The present application claims priority to India Provisional Application No. 202441006691 filed on Feb. 1, 2024, which is incorporated herein by reference.

### FIELD OF THE DISCLOSURE

The present disclosure relates generally to a fuel injector for injection of fuel to a prime mover and, more particularly, to a valve assembly for a fuel injector configured to reduce non-linearity in fuel flow during opening of the valve assembly.

### BACKGROUND

Fuel injectors for internal combustion engines use one or more valves to control the injection of fuel into the combustion chambers or intakes of the engine at precisely controlled quantities, rates, and timing. Some fuel injectors include a plunger that is axially displaced to unobstruct one or more sidewall inlets that allow the fuel to flow into the fuel injector passage and out of the fuel injector. As the plunger is displaced, particularly at low plunger lift and low fuel flow conditions and also at high plunger lift and high fuel flow conditions, a substantially non-linear relationship exists between the plunger displacement and the flow area that is created through the one or more sidewall inlets. As a result, the flow rate of fuel into the fuel injector passage is also non-linear during the initial and final stages of plunger displacement.

The fuel flow control logic in the engine controller attempts to account for this non-linearity in fuel flow at low and high plunger lifts in order to provide the required precise fueling control. The control logic must therefore be able to accurately predict and/or model the non-linear performance that will result as the plunger is lifted, which results in increased complexity and may result in reduced accuracy in determining the quantities, rates, and timing for fuel injection and fluctuating performance. Therefore, there remains a need for the unique apparatuses, systems, and techniques disclosed herein.

### DISCLOSURE OF ILLUSTRATIVE EMBODIMENTS

For the purposes of clearly, concisely and exactly describing illustrative embodiments of the present disclosure, the manner, and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created and that the invention includes and protects such alterations, modifications, and further applications of the exemplary embodiments as would occur to one skilled in the art.

### SUMMARY

The present disclosure includes a fuel injector for providing fuel to a prime mover, including hydrogen fuel cells and other applications employing gaseous fuel. In an embodiment, the fuel injector includes an elongated injector body defining a longitudinally extending passage therein. The passage extends in a distal direction from a first end to a fuel outlet end of the injector body. The fuel injector also includes a valve assembly mounted in the injector body. The valve assembly includes an actuator, a plunger, and a valve seat. The plunger is controllably displaced by the actuator to control fuel flow into the fuel injector and from the fuel injector to the prime mover.

An embodiment of the present disclosure includes a valve assembly for a fuel injector to selectively provide fuel flow through an injector body of the fuel injector. The valve assembly includes an actuator, a valve seat positionable in a passage of the injector body, and a plunger at least partially within and sealingly engaged to the valve seat in a closed position of the valve assembly. The plunger extends in a proximal direction from the valve seat in the passage and is coupled to the actuator. The plunger is longitudinally movable by the actuator to progressively increase a flow area of an inlet of the injector body into the passage to provide fuel flow into the passage. The plunger disengages the valve seat as the plunger is longitudinally moved by the actuator to open the valve assembly and provide fuel flow through an opening of the valve seat.

An embodiment of the present disclosure includes a fuel injector for providing fuel to a prime mover. The fuel injector includes an elongated injector body defining a longitudinally extending passage therein. The passage extends in a distal direction from a first end of the injector body toward an outlet end of the injector body. The injector body includes at least one inlet extending radially through the injector body in fluid communication with the passage. The fuel injector also includes a valve assembly including an actuator, a valve seat in the passage downstream of the at least one inlet, and a plunger that is longitudinally displaceable in the passage by the actuator to control fuel flow from the fuel injector to the prime mover. The plunger includes a first flow control portion longitudinally movable along the at least one inlet to control fuel flow through the at least one inlet into the passage. The plunger also includes a second flow control portion operably associated with the first flow control portion. The second flow control portion sealingly engages the valve seat in a closed position of the valve assembly in which there is no fuel flow through the valve seat while the first flow control portion of the plunger is positioned to admit fuel into the passage through the at least one inlet. The plunger is longitudinally movable in the passage to disengage the second flow control portion from the valve seat to provide fuel flow through the valve seat while simultaneously increasing a first flow area through the at least one inlet and increasing a second flow area through the valve seat as the plunger is longitudinally displaced in the passage to a fully open position.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic view of a fuel injection system.

FIG. 2 is a longitudinal section view illustrating an example valve assembly for a fuel injector of the system of FIG. 1, according to an embodiment of the present disclosure.

FIG. 3 is a partial longitudinal section view of the valve assembly of FIG. 2 with the valve seat in a closed position by engagement with the plunger.

FIG. 4 is a partial longitudinal section view of the valve assembly of FIG. 2 in an initial stage of opening of the valve seat by displacement of the plunger.

FIG. 5 is a partial longitudinal section view of the valve assembly of FIG. 2 in an intermediate stage of opening of the valve seat.

FIG. 6 is a partial longitudinal section view of the valve assembly of FIG. 2 in a final stage of opening to a completely open position of the valve seat.

FIG. 7 is a graph showing plunger lift versus flow rate during opening of the valve assembly of FIG. 2.

### DETAILED DESCRIPTION OF ILLUSTRATIVE EMBODIMENTS

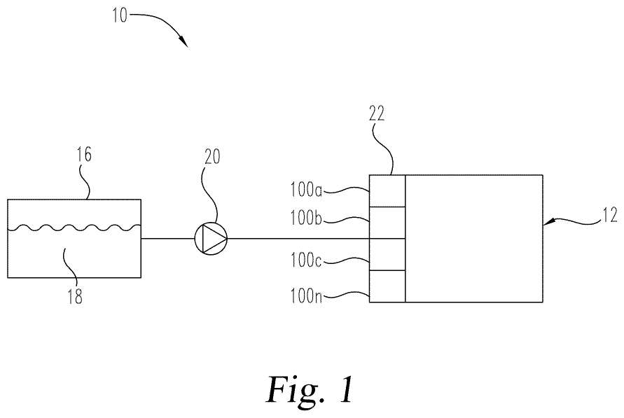

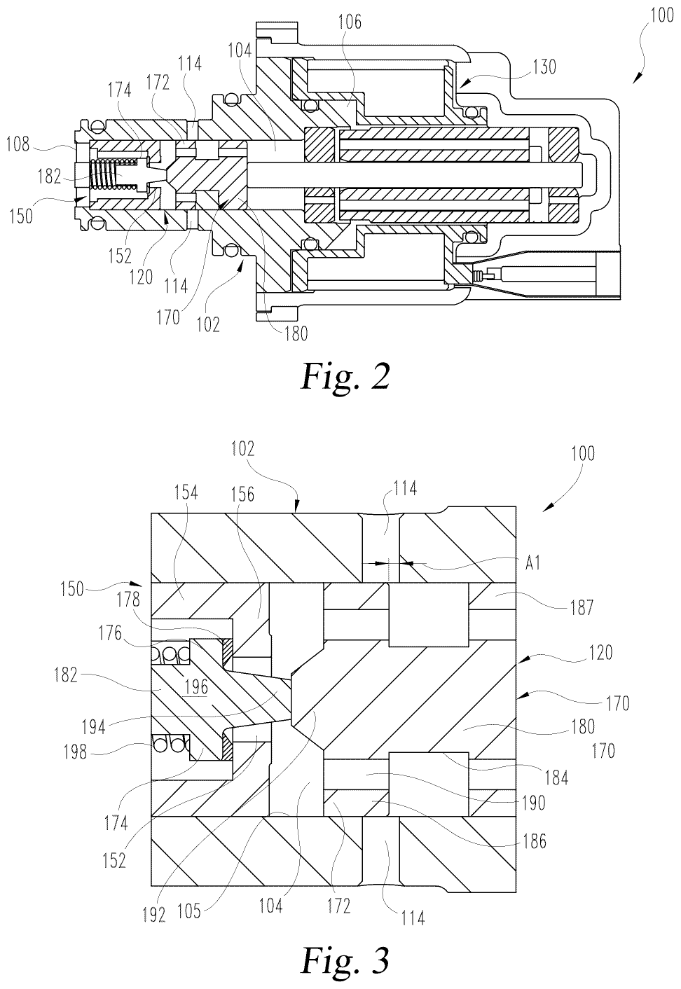

With reference to FIG. 1, there is illustrated a fuel injection system 10 including at least one fuel injector 100a, 100b, 100c . . . 100n for a fuel supply system 22 of a prime mover 12, such as an internal combustion engine or fuel cell. Fuel supply system 22 may include, for example, a combustion chamber, intake manifold, intake plumbing, compressor, fuel mixer, or any other fuel supply system. The at least one fuel injector 100a, 100b, 100c . . . 100n is in fluid communication with a fuel source 16 containing a fuel 18, and a fuel tank/regulator 20 to distribute fuel 18 to the injectors 100a, 100b, 100c . . . 100n. Although multiple fuel injectors are shown schematically in FIG. 1, system 10 may include any number of fuel injectors, including one fuel injector. Pressurized fuel 18 is supplied to each of the fuel injectors 100a, 100b, 100c . . . 100n from the fuel tank/regulator 20. Fuel 18 may be, for example, gaseous, fuel such as hydrogen, propane, natural gas, etc. Fuel 18 may also be liquid fuel such as diesel or gasoline. In the discussion that follows, fuel injectors 100a, 100b, 100c . . . 100n are described with reference to a fuel injector 100, such as shown in FIGS. 2-6.

In an embodiment, the fuel injector 100 provides fuel to a prime mover 12. The fuel injector 100 includes an elongated injector body 102 defining a longitudinally extending passage 104 therein. Passage 104 extends in a distal direction from a first end 106 toward an outlet end 108 of injector body 102. Injector body 102 includes at least one inlet 114 extending radially through injector body 102 in fluid communication with passage 104.

Fuel injector 100 also includes a valve assembly 120 in passage 104. Valve assembly 120 includes an actuator 130, a valve seat 150 in passage 104 downstream of the at least one inlet 114, and a plunger 170 that is longitudinally displaceable in passage 104 by actuator 130 to control fuel flow from fuel injector 100 to prime mover 12. Plunger 170 includes a first flow control portion 172 longitudinally movable along the at least one inlet 114 to control fuel flow through the at least one inlet 114 into passage 104. Plunger 170 also includes a second flow control portion 174 operably associated with first flow control portion 172. Second flow control portion 174 sealingly engages valve seat 150 in a closed position of valve assembly 120 in which there is no fuel flow through valve seat 150 while first flow control portion 172 of plunger 170 is positioned to admit fuel into passage 104 through the at least one inlet 114. Plunger 170 is longitudinally movable in passage 104 to disengage second flow control portion 174 from valve seat 150 to provide fuel flow through valve seat 150 while simultaneously increasing a first flow area through the at least one inlet 114 and increasing a second flow area through valve seat 150 as plunger 170 is longitudinally displaced in passage 104 to a fully open position.

In an embodiment, valve assembly 120 is provided for fuel injector 100 to selectively provide fuel flow through injector body 102 of fuel injector 100. Valve assembly 120 includes actuator 130, valve seat 150 positionable in passage 104 of injector body 102, and plunger 170 at least partially within and sealingly engaged to valve seat 150 in a closed position of valve assembly 120. Plunger 170 extends in a proximal direction from valve seat 150 in passage 104 and is coupled to actuator 130. Plunger 170 is longitudinally movable by actuator 130 to progressively increase a flow area of inlet 114 of injector body 102 into passage 104 to provide fuel flow into passage 104. Plunger 170 disengages valve seat 150 as plunger 170 is longitudinally moved by actuator 130 to open valve assembly 120 and provide fuel flow through an opening 152 of valve seat 150.

The exemplary injector body 102 in FIG. 2 for an embodiment of fuel injector 100 extends longitudinally along a central longitudinal axis A and includes passage 104 that is defined by the injector body 102 from first end 106 to or toward gas outlet end 108. The longitudinally extending passage 104 receives valve assembly 120. Valve assembly 120 includes valve seat 150, plunger 170, and actuator 130 to control fuel flow through laterally extending inlet(s) 114 into passage 104 and through opening 152 of valve seat 150. In the discussion herein, “proximal” or “proximally” refer to an axial location or upstream direction toward first end 106 and/or actuator 130, and “distal” or “distally” refers to an axial location or downstream direction toward outlet end 108. Injector body 102 can be comprised of multiple parts that are coupled to one another to form injector body 102, or a single sleeve or component that forms injector body 102.

In an embodiment, plunger 170 includes a first plunger portion 180 and a second plunger portion 182 operably associated with first plunger portion 180. First flow control portion 172 is provided on first plunger portion 180, and second flow control portion 174 is provided on second plunger portion 182. First plunger portion 180 is located proximally of valve seat 150. Second plunger portion 182 is located at least partially in valve seat 150 and extends proximally through opening 152 of valve seat 150.

In an embodiment, first plunger portion 180 is positioned in abutting end-to-end engagement with second plunger portion 182. Longitudinal displacement of first plunger portion 180 with actuator 130 longitudinally displaces second plunger portion 182 in passage 104. Other embodiments contemplate other configurations for first and second plunger portions 180, 182, such as a unitary body for plunger 170, or more than two plunger portions operably associated with one another.

In the illustrated embodiment, valve seat 150 is positioned within passage 104 and engaged to injector body 102. Valve seat 150 includes a cylindrical shell 154. Shell 154 includes an end wall 156 defining opening 152. Opening 152 is opened and closed by plunger 170. In the illustrated embodiment, plunger 170, and in particular second plunger portion 182, extends through opening 152 of end wall 156 of shell 154. Second plunger portion 182 of plunger 170 includes a radially protruding flange 176 that is located within shell 154. A seal 178 is secured to and supported on flange 176 and/or end wall 156 of valve seat 150. Seal 178 sealingly engages end wall 156 of shell 154 around opening 152 when valve assembly 120 is in the closed position.

In an embodiment, second flow control portion 174 of plunger 170 is formed by flange 176 and seal 178. In an embodiment, seal 178 is an elastomer seal at the sealing interface of flange 176 and end wall 156 around opening 152. Seal 178 provides a fluid-tight seal to prevent fuel flow, such as gaseous fuel flow or liquid fuel flow, through opening 152 unless plunger 170 is distally longitudinally displaced.

First plunger portion 180 includes a stem portion 184 and a radially protruding portion 186 extending radially outwardly from stem portion 184. In an embodiment, first flow control portion 172 is formed by the sealing engagement of radially protruding portion 186 with an inner surface 105 of injector body 102 along inlet(s) 114. First plunger portion 180 is longitudinally movable along inlet(s) 114 to control fuel flow through the inlet(s) 114 into passage 104 via first flow control portion 172 progressively increasing the open flow area of inlet(s) 114 into passage 104, as shown in FIGS. 3-6. Radially protruding portion 186 includes at least one longitudinal bore 190 therethrough that is configured to allow fuel flow in a distal direction toward valve seat 150.

In an embodiment, first plunger portion 180 includes a second radially protruding portion 187 extending radially outwardly from stem portion 184. Second radially protruding portion 187 is located proximally of inlet(s) 114 and contacts the inner surface 105 of injector body 102 to guide longitudinal movement of first plunger portion 180 along injector body 102. Second radially protruding portion 187 may include a longitudinal passage to allow fuel flow therethrough.

In an embodiment, first plunger portion 180 includes a tapered nose 192 extending distally from radially protruding portion 186 to contact second plunger portion 182. Second plunger portion 182 includes a second tapered nose 194 extending proximally through opening 152 in valve seat 150 to contact the tapered nose 192 of first plunger portion 180. Second plunger portion 182 includes flange 176 in valve seat 150 that extends radially outwardly from second tapered nose 194.

In an embodiment, second plunger portion 182 includes a shaft portion 196 housed in shell 154 with second tapered nose 194 extending from shaft portion 196 and protruding from shell 154 through hole 152. Flange 176 extends radially outwardly from shaft portion 196 in order to contact valve seat 150 in the closed position of valve assembly 120. A spring 198 can be positioned around shaft portion 196 of second plunger portion 182. Spring 198 is in contact with radially extending flange 176 in order to bias seal 178 of radially extending flange 176 into contact with end wall 156 of valve seat 150.

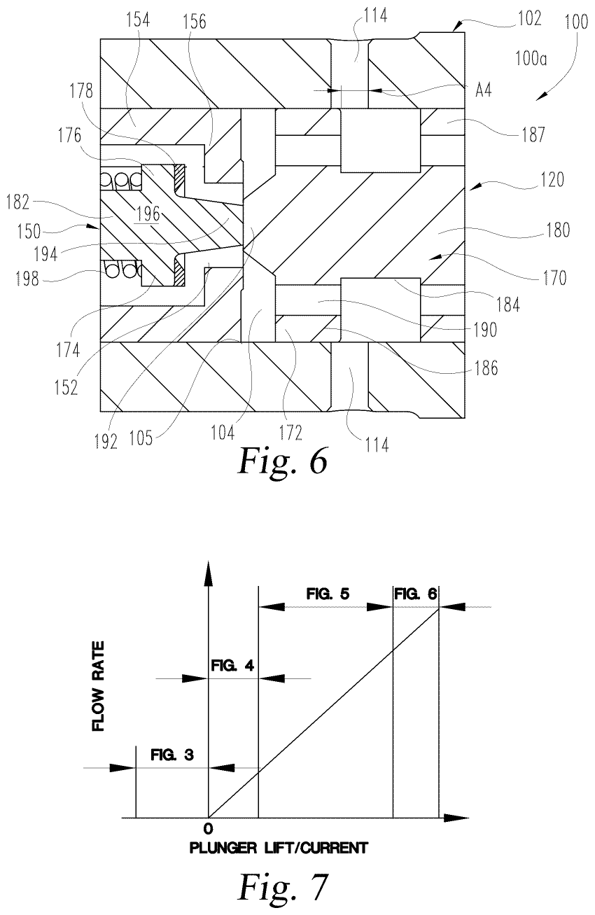

Referring to FIG. 3, valve assembly 120 is shown in a closed position such that no fuel flow is allowed through seat 150. However, inlet(s) 114 are partially open by the longitudinal position of plunger 170. In particular, first flow control portion 172 is located along inlet(s) 114 so that a proximal side of inlet(s) 114 are open to admit fuel flow into passage 104 through flow area A1. Longitudinal bore 190 allows fuel to flow through radially protruding portion 186 to occupy the volume in passage 104 on the proximal side of valve seat 150. As shown in FIG. 7, there is no fuel flow through valve seat 150 in the closed position of valve assembly 120.

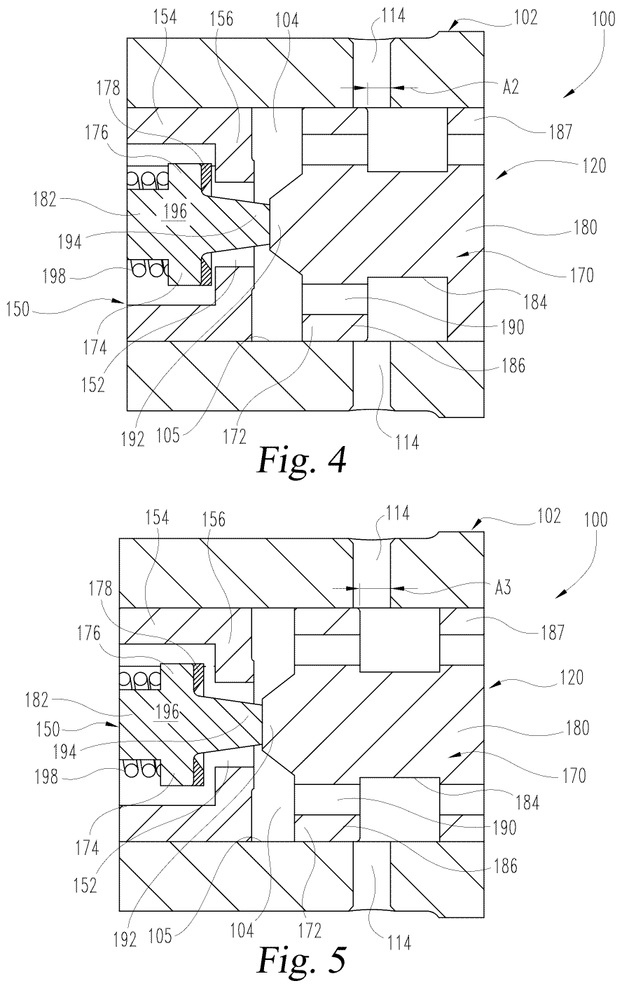

Referring to FIG. 4, valve assembly 120 is shown in an initial stage of opening such that fuel flow is allowed through opening 152 of valve seat 150. Inlet(s) 114 are opened a slightly further amount by the longitudinal, distal displacement of plunger 170. In particular, first flow control portion 172 is located further distally along inlet(s) 114 than when in the closed position, and second flow control portion 174 of plunger 170 is disengaged from valve seat 150 to provide a flow area A2 greater than flow area A1. The flow area provided by inlet(s) 114 into passage 104 is greater than the flow area provided through opening 152 of valve seat 150. Therefore, the fuel flow rate through opening 152 is controlled at valve seat 150 by the location of second flow control portion 174 of plunger 170. As shown in FIG. 7, the fuel flow rate linearly increases in this initial stage of opening of valve assembly 150 as second flow control portion 174 of plunger 170 is displaced away from engagement with valve seat 150 in the closed position of valve assembly 120.

Referring to FIG. 5, valve assembly 120 is shown in an intermediate stage of opening such that an increasing amount of fuel flow is allowed through valve seat 150 by creating a progressively greater flow area through valve seat opening 152. Inlet(s) 114 are also further opened by the longitudinal, distal displacement of first flow control portion 172 of plunger 170 along the inlet(s) 114 to provide a flow area A3 greater than flow area A2. However, the flow area provided by inlet(s) 114 into passage 104 is less than the flow area provided through opening 152 of valve seat 150. Therefore, during the intermediate stage of opening fuel flow rate through valve seat 150 is controlled by first fuel flow control portion 172 at inlet(s) 114. As shown in FIG. 7, the fuel flow rate continues to linearly increase in this initial stage of opening of valve assembly 150 as second flow control portion 174 of plunger 170 is displaced away from valve seat 150 from the closed position of valve assembly 120.

Referring to FIG. 6, valve assembly 120 is shown in a fully open stage of opening such that a maximum amount of fuel flow is allowed through opening 152 of valve seat 150 by the longitudinal displacement of second flow control portion 174 of plunger 170. Inlet(s) 114 are also further opened by the longitudinal, distal displacement of plunger 170 to provide a flow area A4 greater than flow area A3. However, inlet(s) 114 are not fully open and remain at least partially obstructed by first flow control portion 172 of plunger 170 to maintain linearity in the increase of the fuel flow rate to the fully open position, as shown in FIG. 7.

Further written description of a number of example embodiments shall now be provided. In an example embodiment, a fuel injector for providing fuel to a prime mover is provided. The fuel injector includes an elongated injector body defining a longitudinally extending passage therein. The passage extends in a distal direction from a first end of the injector body toward an outlet end of the injector body. The injector body includes at least one inlet extending radially through the injector body in fluid communication with the passage. The fuel injector includes a valve assembly including an actuator, a valve seat in the passage downstream of the at least one inlet, and a plunger that is longitudinally displaceable in the passage by the actuator to control fuel flow from the fuel injector to the prime mover. The plunger includes a first flow control portion longitudinally movable along the at least one inlet to control fuel flow through the at least one inlet into the passage. The plunger also includes a second flow control portion operably associated with the first flow control portion. The second flow control portion sealingly engages the valve seat in a closed position of the valve assembly in which there is no fuel flow through the valve seat with the first flow control portion of the plunger positioned to admit fuel into the passage through the at least one inlet. The plunger is longitudinally movable in the passage to disengage the second flow control portion from the valve seat to provide fuel flow through the valve seat while simultaneously increasing a first flow area through the at least one inlet and increasing a second flow area through the valve seat as the plunger is longitudinally displaced in the passage to a fully open position.

In an embodiment, the plunger includes a first plunger portion in the passage and a second plunger portion at least partially within the valve seat. The first plunger portion includes the first flow control portion, and the first plunger portion abuttingly engages the second plunger portion so that longitudinal displacement of the first plunger portion with the actuator longitudinally displaces the second plunger portion.

In a further embodiment, the first plunger portion includes a stem portion and a radially protruding portion extending radially outwardly from the stem portion. The radially protruding portion contacts an inner surface of the injector body and overlaps the at least one inlet in the closed position and the fully open position.

In a further embodiment, the radially protruding portion includes at least one longitudinal bore that allows fuel to flow from the inlet through the radially protruding portion.

In a further embodiment, the first plunger portion includes a second radially protruding portion extending radially outwardly from the stem portion. The second radially protruding portion is located proximally of the at least one inlet and contacts the inner surface of the injector body to guide longitudinal movement of the first plunger portion along the injector body.

In a further embodiment, the second plunger portion includes a shaft portion and a radially extending flange extending radially outwardly from the shaft portion. The radially extending flange contacts the valve seat in the closed position.

In a further embodiment, the second plunger portion includes a seal on the radially extending flange that sealingly engages the valve seat in the closed position.

In a further embodiment, a spring around the shaft portion of the second plunger portion is in contact with the radially extending flange. The spring biases the radially extending flange into contact with the valve seat.

In a further embodiment, the valve seat includes a cylindrical shell in the passage of the injector body. The shell at least partially houses the second plunger portion. The shell includes an end wall defining an opening that is opened and closed by the second plunger portion.

In a further embodiment, the second plunger portion protrudes through the opening in the end wall of the shell.

According to a further aspect of the disclosure, a valve assembly for a fuel injector to selectively provide fuel flow through an injector body of the fuel injector is provided. The valve assembly includes an actuator and a valve seat positionable in a passage of the injector body. The valve assembly also includes a plunger at least partially within and sealingly engaged to the valve seat in a closed position of the valve assembly. The plunger extends in a proximal direction from the valve seat in the passage. The plunger is coupled to the actuator and is longitudinally movable by the actuator to progressively increase a flow area of an inlet of the injector body into the passage to provide fuel flow into the passage. The plunger disengages the valve seat as the plunger is longitudinally moved by the actuator to open the valve assembly and provide fuel flow through an opening of the valve seat.

In an embodiment, the plunger includes a first flow control portion longitudinally movable along the inlet to control fuel flow through the inlet into the passage. The plunger also includes a second flow control portion operably associated with the first flow control portion. The second flow control portion sealingly engaging the valve seat in the closed position.

In a further embodiment, the plunger is longitudinally movable in the passage in a distal direction to disengage the second flow control portion from the valve seat to provide fuel flow through opening of the valve seat while simultaneously increasing the flow area through the inlet and increasing a second flow area through the opening of the valve seat.

In an embodiment, the valve seat includes a cylindrical shell. The shell includes an end wall defining the opening that is opened and closed by the plunger.

In a further embodiment, the plunger extends through the opening in the end wall of the shell. The plunger includes a flange that is located within the shell. A seal on the flange sealingly engages the shell around the opening in the closed position.

In an embodiment, the plunger includes a first plunger portion located proximally of the valve seat and a second plunger portion in the valve seat that extends proximally through the opening of the valve seat. The first plunger portion is in abutting end-to-end engagement with the second plunger portion.

In a further embodiment, the first plunger portion includes a radially protruding portion configured to sealingly engage the injector body along the inlet. The radially protruding portion includes at least one longitudinal bore therethrough.

In a further embodiment, the first plunger portion includes a tapered nose extending distally from the radially protruding portion to contact the second plunger portion.

In a further embodiment, the second plunger portion includes a second tapered nose extending proximally through the opening in the valve seat to contact the tapered nose of the first plunger portion.

In a further embodiment, the second plunger portion includes a flange in the valve seat that extends radially outwardly from the second tapered nose.

According to another aspect of the present disclosure, a valve assembly for a fuel injector to selectively provide fuel flow through an injector body of the fuel injector is provided. The valve assembly includes an actuator, a valve seat positionable in a passage of the injector body, and a plunger at least partially within valve seat. The plunger extends in a proximal direction from the valve seat in the passage. The valve assembly also includes an elastomer seal between the valve seat and the plunger to sealingly close the valve assembly in a closed position of the valve assembly. The plunger is coupled to the actuator and the plunger is longitudinally movable by the actuator to progressively increase a flow area of an inlet of the injector body into the passage to provide fuel flow into the passage. The plunger disengages the valve seat as the plunger is longitudinally moved by the actuator to unseal the valve assembly and provide fuel flow through an opening of the valve seat.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel injector for providing fuel to a prime mover, the fuel injector comprising:
an elongated injector body defining a longitudinally extending passage therein, the passage extending in a distal direction from a first end of the injector body toward an outlet end of the injector body, the injector body including at least one inlet extending radially through the injector body in fluid communication with the passage; and
a valve assembly including an actuator, a valve seat in the passage downstream of the at least one inlet, and a plunger that is longitudinally displaceable in the passage by the actuator to control fuel flow from the fuel injector to the prime mover, wherein:
the plunger includes a first flow control portion longitudinally movable along the at least one inlet to control fuel flow through the at least one inlet into the passage;
the plunger includes a second flow control portion operably associated with the first flow control portion, the second flow control portion sealingly engaging the valve seat in a closed position of the valve assembly in which there is no fuel flow through the valve seat with the first flow control portion of the plunger positioned to admit fuel into the passage through the at least one inlet; and
the plunger is longitudinally movable in the passage to disengage the second flow control portion from the valve seat to provide fuel flow through the valve seat while simultaneously increasing a first flow area through the at least one inlet and increasing a second flow area through the valve seat as the plunger is longitudinally displaced in the passage to a fully open position.

2. The fuel injector of claim 1, wherein the plunger includes:
a first plunger portion in the passage, the first plunger portion including the first flow control portion; and
a second plunger portion at least partially within the valve seat, the second plunger portion including the second flow control portion, wherein the first plunger portion abuttingly engages the second plunger portion so that longitudinal displacement of the first plunger portion with the actuator longitudinally displaces the second plunger portion.

3. The fuel injector of claim 2, wherein the first plunger portion includes:
a stem portion; and
a radially protruding portion extending radially outwardly from the stem portion, wherein the radially protruding portion contacts an inner surface of the injector body and overlaps the at least one inlet in the closed position and the fully open position.

4. The fuel injector of claim 3, wherein the radially protruding portion includes at least one longitudinal bore that allows fuel to flow from the inlet through the radially protruding portion.

5. The fuel injector of claim 3, wherein the first plunger portion includes a second radially protruding portion extending radially outwardly from the stem portion, wherein the second radially protruding portion is located proximally of the at least one inlet and contacts the inner surface of the injector body to guide longitudinal movement of the first plunger portion along the injector body.

6. The fuel injector of claim 2, wherein the second plunger portion includes:
a shaft portion; and
a radially extending flange extending radially outwardly from the shaft portion, wherein the radially extending flange contacts the valve seat in the closed position.

7. The fuel injector of claim 6, wherein the second plunger portion includes a seal on the radially extending flange that sealingly engages the valve seat in the closed position.

8. The fuel injector of claim 6, comprising a spring around the shaft portion of the second plunger portion that is in contact with the radially extending flange, the spring biasing the radially extending flange into contact with the valve seat.

9. The fuel injector of claim 2, wherein the valve seat includes a cylindrical shell in the passage of the injector body, the shell at least partially housing the second plunger portion, the shell including an end wall defining an opening that is opened and closed by the second plunger portion.

10. The fuel injector of claim 9, wherein the second plunger portion protrudes through the opening in the end wall of the shell.

11. A valve assembly for a fuel injector to selectively provide fuel flow through an injector body of the fuel injector, the valve assembly comprising:
an actuator; and
a valve seat positionable in a passage of the injector body;
a plunger at least partially within and sealingly engaged to the valve seat in a closed position of the valve assembly, the plunger extending in a proximal direction from the valve seat in the passage, wherein:
the plunger is coupled to the actuator;
the plunger is longitudinally movable by the actuator to progressively increase a flow area of an inlet of the injector body into the passage to provide fuel flow into the passage; and
the plunger disengages the valve seat as the plunger is longitudinally moved by the actuator to open the valve assembly and provide fuel flow through an opening of the valve seat.

12. The valve assembly of claim 11, wherein:
the plunger includes a first flow control portion longitudinally movable along the inlet to control fuel flow through the inlet into the passage; and
the plunger includes a second flow control portion operably associated with the first flow control portion, the second flow control portion sealingly engaging the valve seat in the closed position.

13. The valve assembly of claim 12, wherein:
the plunger is longitudinally movable in the passage in a distal direction to disengage the second flow control portion from the valve seat to provide fuel flow through opening of the valve seat while simultaneously increasing the flow area through the inlet and increasing a second flow area through the opening of the valve seat.

14. The valve assembly of claim 11, wherein the valve seat includes a cylindrical shell, the shell including an end wall defining the opening that is opened and closed by the plunger.

15. The valve assembly of claim 14, wherein:
the plunger extends through the opening in the end wall of the shell;
the plunger includes a flange that is located within the shell; and
a seal on the flange sealingly engages the shell around the opening in the closed position.

16. The valve assembly of claim 11, wherein the plunger includes:
a first plunger portion located proximally of the valve seat; and
a second plunger portion in the valve seat that extends proximally through the opening of the valve seat, first plunger portion in abutting end-to-end engagement with the second plunger portion.

17. The valve assembly of claim 16, wherein the first plunger portion includes a radially protruding portion configured to sealingly engage the injector body along the inlet, the radially protruding portion including at least one longitudinal bore therethrough.

18. The valve assembly of claim 17, wherein the first plunger portion includes a tapered nose extending distally from the radially protruding portion to contact the second plunger portion.

19. The valve assembly of claim 18, wherein the second plunger portion includes a second tapered nose extending proximally through the opening in the valve seat to contact the tapered nose of the first plunger portion.

20. The valve assembly of claim 19, wherein the second plunger portion includes a flange in the valve seat that extends radially outwardly from the second tapered nose.

21. A valve assembly for a fuel injector to selectively provide fuel flow through an injector body of the fuel injector, the valve assembly comprising:
an actuator;
a valve seat positionable in a passage of the injector body;
a plunger at least partially within valve seat, the plunger extending in a proximal direction from the valve seat in the passage; and
an elastomer seal between the valve seat and the plunger to sealingly close the valve assembly in a closed position of the valve assembly, wherein:
the plunger is coupled to the actuator;
the plunger is longitudinally movable by the actuator to progressively increase a flow area of an inlet of the injector body into the passage to provide fuel flow into the passage; and
the plunger disengages the valve seat as the plunger is longitudinally moved by the actuator to unseal the valve assembly and provide fuel flow through an opening of the valve seat.
